(19) United States
(12) Patent Application Publication
(10) Pub. No.: US 2005/0157329 A1
(43) Pub. Date: Jul. 21, 2005

(54) System and method for printing data of portable terminal

(75) Inventors: Dong-Ik Park, Suwon-si (KR); Hyung-Tae Kim, Seoul (KR); Jung-Cheon Choi, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 10/918,921

(22) Filed: Aug. 16, 2004

(30) Foreign Application Priority Data
Jan. 15, 2004 (KR) 2004-3066

(51) Int. Cl. G06F 15/00; G06F 15/12; H04B 7/00; G06F 3/12

(52) U.S. Cl. 358/1.15; 358/1.6; 455/41.3

(57) ABSTRACT

A system for printing data from a portable terminal including: a portable terminal for storing printable printing data and transmitting data selected by the user to an external device using short-distance wireless communication, when the user's request for printing the data is present; and a wireless printer that receives the selected printing data by the short-distance communication with the portable terminal and prints the received data. In the system, wire cables are not necessary for each piece of equipment and the data transmission time is reduced, because the data of the portable terminal is directly transmitted to the wireless printer and is printed thereby without using an intermediate device such as a PC.

### PRIORITY

This application claims priority to an application entitled “SYSTEM AND METHOD FOR PRINTING DATA OF PORTABLE TERMINAL” filed in the Korean Industrial Property Office on Jan. 15, 2004 and assigned Serial No. 2004-3066, the contents of which are hereby incorporated by reference.

### BACKGROUND OF THE INVENTION

1. Field of the Invention

The present invention relates to a system and a method for printing data from a portable terminal.

2. Description of the Related Art

Generally, a portable terminal utilizes a separate device such as a PC (Personal Computer), when the data of the portable terminal, for example images and text downloaded from other devices or prepared on the portable terminal itself, is printed.

FIG. 1 illustrates a system for printing data of a portable terminal according to the prior art. As shown in FIG. 1, the portable terminal 2 is connected to a PC 4 by means of a wire cable such as an USB (Universal Serial Bus) cable in order to transmit data to be printed from the portable terminal 2 to the PC 4. The PC 4 is connected to a printing device 8 by means of a wire cable such as an USB cable. When the user's request for printing the desired data is present among the data to be printed, the PC 4 receives printing data from the portable terminal 2, and transmits desired data for printing and a request signal for printing the desired data to the printing device 8. The printing device 8 receives the request signal and the desired data to be printed and prints the received data.

However, the method of the prior art as described above has a disadvantage in that wire cables are needed for each piece of equipment, because the portable terminal is connected to the PC 4 by means of a wire cable in order to transmit the data to be printed to the PC 4 and the data transmitted to the PC 4 is further transmitted to the printing device 8. In addition, the method of the prior art has a problem in that the transmission of the data requires long time and is complicate, since the data of the portable terminal is transmitted repeatedly, from the portable terminal 2 to the PC 4 and from the PC 4 to the printing device 8.

### SUMMARY OF THE INVENTION

Accordingly, the present invention has been made to solve the above-mentioned problems occurring in the prior art, and an object of the present invention is to provide a system and a method for printing data of a portable terminal, wherein the data is directly transmitted to a printing device by wireless communication without using an intermediate device so that the data transmission time can be reduced and the data can be printed with ease.

In order to accomplish this object, there is provided a system for printing data of a portable terminal, the system comprising: a portable terminal that stores printable printing data and transmits desired data selected by the user to an external device using short-distance wireless communication, when the user's request for printing the data is present; and a wireless printer that receives the desired printing data by the short-distance communication with the portable terminal and prints the received printing data.

In accordance with another aspect of the present invention, there is provided a method for printing data of a portable terminal, the method comprising the steps of: displaying the printing data stored previously on the portable terminal, when the request for printing desired data is present, and transmitting the desired printing data using a short-distance wireless communication unit, when the desired printing data is selected; and receiving the desired printing data by a wireless printer using a short-distance wireless communication unit and printing the received printing data.

### BRIEF DESCRIPTION OF THE DRAWINGS

The above and other objects, features and advantages of the present invention will be more apparent from the following detailed description taken in conjunction with the accompanying drawings, in which:

FIG. 1 is a system for printing data of a portable terminal according to the prior art;

FIG. 2 is a system for printing data of a portable terminal according to a preferred embodiment of the present invention;

FIG. 3 is a block diagram of a system for printing data of a portable terminal according to a preferred embodiment of the present invention;

FIG. 4 is a block diagram of a short-distance wireless communication unit according to a preferred embodiment of the present invention;

FIG. 5 is a flow chart of a transmission process for printing data in a portable terminal according to a preferred embodiment of the present invention; and

FIG. 6 is a flow chart of a printing process for printing data received by a wireless printer according to a preferred embodiment of the present invention.

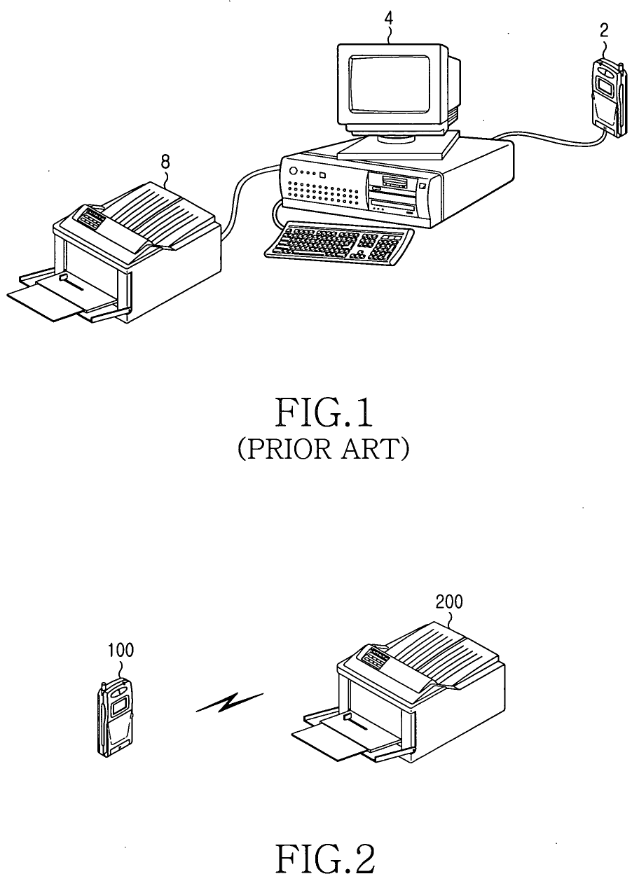

### DETAILED DESCRIPTION OF THE PREFERRED EMBODIMENT

Hereinafter, preferred embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention unclear.

FIG. 2 is a system for printing data of a portable terminal according to a preferred embodiment of the present invention. More particularly, in the system for printing data of a portable terminal according to a preferred embodiment of the present invention as shown in FIG. 2, a portable terminal 100 carries out short-distance wireless communication between a wireless printer 200 and a PC 4 by means of a technology such as Bluetooth, Zigbee and UWB (Ultra Wide Band). The portable terminal 100 transmits data such as image or text downloaded from other devices or prepared on the portable terminal 100 itself to the wireless printer 200 using the short-distance wireless communication. The wireless printer 200 receives data from the portable terminal 100 and prints the received data.

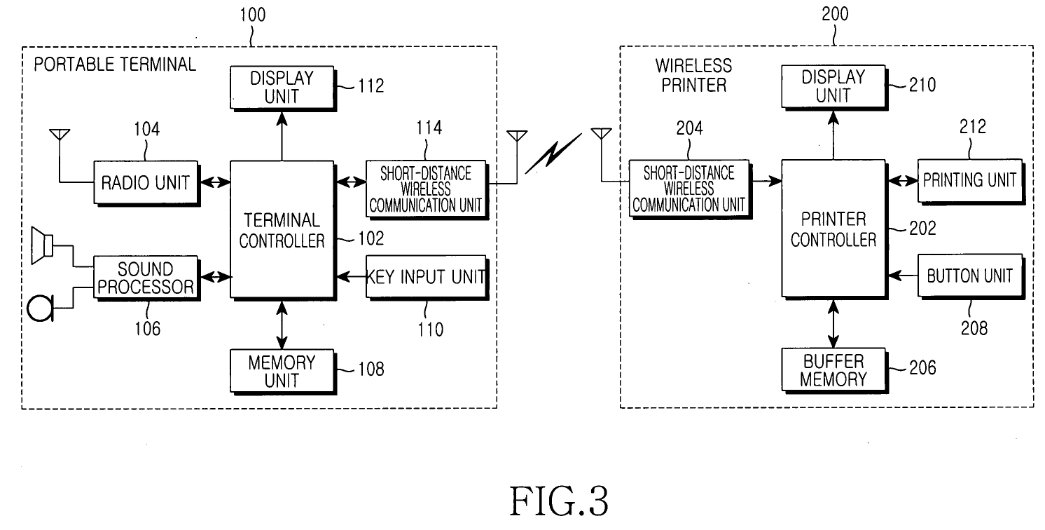

FIG. 3 is a block diagram of a system for printing data of a portable terminal according to a preferred embodiment of the present invention. The portable terminal 100 and the wireless printer 200 of the system for printing data of a portable terminal according to a preferred embodiment of the present invention will be explained hereinafter in detail.

First, the portable terminal 100 comprises a terminal controller 102, a radio unit 104, a sound processor 106, a memory unit 108, a key input unit 110, a display unit 112 and a short-distance wireless communication unit 114.

Particularly, the terminal controller 102 carries out general control actions for the portable terminal 100, and performs a control action needed to transmit desired data to be printed to the wireless printer 200 by using short-distance wireless communication, when the user's request for printing the desired data is present.

The radio unit 104 performs transmission/reception of wireless data, such as sound data and control data to/from an outside base station under the control of the terminal controller 102. For example, data such as images or text is downloaded to the radio unit 104 by the transmission/reception of wireless data to/from the outer base station.

The sound processor 106 transforms the sound data received by the radio unit 104 into an audible sound, outputs it through a speaker, transforms the sound signal entered from a microphone into sound data, and makes it available for playback.

The memory unit 108 may be formed of a ROM (Read Only Memory) and a RAM (Random Access Memory) etc., the memory unit 108 is used for storing a plurality of programs and data. This memory unit 108 stores data such as images or text downloaded from other devices or prepared in the portable terminal 100 itself by the user according to a preferred embodiment of the present invention.

The key input unit 110 is equipped with a plurality of keys such as various function keys, number keys and special keys. The key input unit 110 outputs a key input signal corresponding to the key pushed by the user, to the terminal controller 102. For example, when the user pushes the key corresponding to any one of the keys for print request, printer selection request and printing data selection request, the key input unit 110 outputs the key input signal corresponding to the button pushed by the user to the terminal controller 102.

The display unit 112 may be formed of an LCD (Liquid Crystal Display) etc., the display unit 112 outputs various display data generated from the terminal. Particularly, the display unit 112 displays peripheral printers of the terminal according to a preferred embodiment of the present invention and printable data such as image or text stored at the memory unit 108.

The short-distance wireless communication unit 114 may be formed of a communication module carrying out short-distance wireless communication, for example Bluetooth, Zigbee and UWB. This short-distance wireless communication unit 114 transmits the printing data requested to be printed to the wireless printer 200 using short-distance wireless communication such as Bluetooth, Zigbee and UWB.

The construction of wireless printer 200 will be explained hereinafter. The wireless printer 200 comprises a wireless printer controller 202, a short-distance wireless communication unit 204, a buffer memory 206, a button unit 208, a display unit 210 and a printing unit 212.

More specifically, the wireless printer controller 202 controls general actions of the wireless printer 200, and performs a control action needed to print the printing data received from the portable terminal 100 according to a preferred embodiment of the present invention.

The short-distance wireless communication unit 204 is similar to the short-distance wireless communication unit 114 of the portable terminal 100 and may be formed of a communication module carrying out short-distance wireless communication, for example Bluetooth, Zigbee and UWB. This short-distance wireless communication unit 204 receives the printing data from the portable terminal 100 using short-distance wireless communication.

The buffer memory 206 temporarily stores the received printing data. The button unit 208 may be formed of various buttons for the user and the interface, and outputs a button-input signal corresponding to the button pushed by the user to the wireless printer controller 202. For example, the button unit 208 is equipped with a button for the initialization or power-off of the wireless printer 200 in the case that an error is generated during the action of the wireless printer 200, a button for print request, etc., and outputs a signal corresponding to the button pushed by the user to the wireless printer controller 202, when the user pushes the button.

The display unit 201 may be formed of a liquid crystal display (LCD) or a LCD and a LED (Light Emitting Diode), the display unit 201 displays the state of the action of the wireless printer 200 under the control of the wireless printer controller 202. For example, the display unit 210 displays the state of printing data reception, while the printing data is received and displays the state of the completion of printing data reception, when the printing data reception is completed, under the control of the wireless printer controller 202. Additionally, the display unit 210 displays an error generation state, when an error is generated during the reception of the printing data.

The printing unit 212 prints the printing data by adjusting an ink nozzle directed by the wireless printer controller 202.

As described above, the portable terminal 100 transmits printing data to be printed to the wireless printer 200 using the short-distance wireless communication unit 114, while the wireless printer 200 receives the printing data using the short-distance wireless communication unit 204 and prints it.

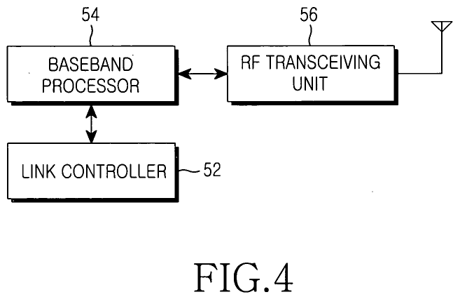

The short-distance wireless communication units 114 and 204 of the portable terminal 100 and of the wireless printer 200, according to the preferred embodiment of the present invention, will be described hereinafter in detail. FIG. 4 is a block diagram of a short-distance wireless communication units 114 and 204 according to a preferred embodiment of the present invention. As shown in FIG. 4, the short-distance wireless communication units 114 and 204 comprise a link controller 52, a baseband processor 54 and an RF (Reference Frequency) transceiving unit 56.

More particularly, the link controller 52 produces a packet for the digital wireless transmission/reception. The baseband processor 54 transforms the packet for the digital wireless transmission/reception produced from the link controller into an analogue signal, receives the analogue signal and transforms it into digital data. The RF transceiving unit 56 receives the RF signal inputted from an antenna, and amplifies and transmits the analogue signal transformed at the baseband processor 54.

The printing process of the portable terminal using the short-distance wireless communication unit will be explained hereinafter.

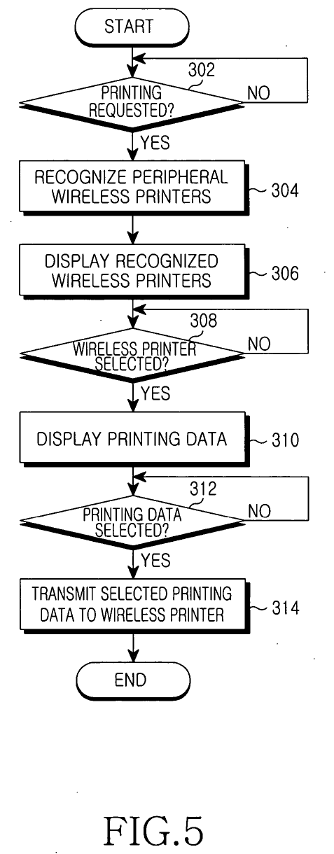

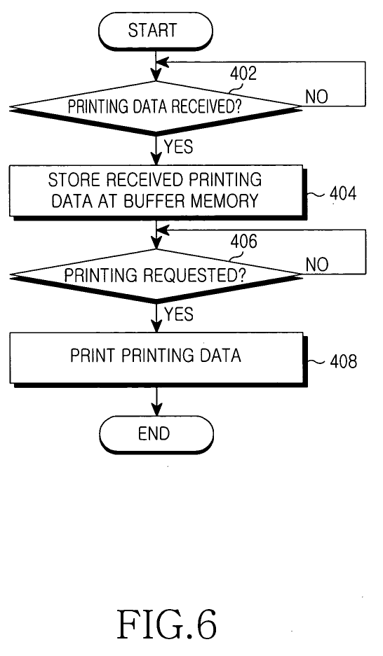

FIG. 5 is a flow chart of a transmission process for printing data in the portable terminal 100 according to a preferred embodiment of the present invention, and FIG. 6 is a flow chart of a printing process for printing data received by the wireless printer 200 according to a preferred embodiment of the present invention.

First, as shown in FIG. 5, at step 302 the portable terminal 100 determines whether the user's request for printing data of the portable terminal is present. For example, the portable terminal 100 recognizes that a print request is present, when a key input signal corresponding to the print request is received from the key input unit 110 by the user and advances to step 304.

At step 304 the portable terminal 100 recognizes a peripheral wireless printer using the short-distance wireless communication unit 114. For example, the portable terminal 100 transmits a signal for searching peripheral wireless printers using the short-distance wireless communication unit 114, and recognizes a designated wireless printer corresponding to the printer identifying information received from the designated wireless printer. Thus, the portable terminal 100 recognizes the peripheral wireless printer, and then, at step 306 displays the recognized wireless printer on the display unit 112. After the portable terminal 100 displays the wireless printer, it determines whether the wireless printer is selected by the user or not at step 308. At step 310 the portable terminal 100 displays printing data to be printed on the display unit 112, when the wireless printer is selected. For example, the printing data is data such as image or text downloaded from other devices or prepared on the portable terminal 100 itself. After the portable terminal 100 displays the printing data, at step 312 it determines whether the printing data is selected by the user. When desired, printing data is selected by the user among the printing data to be printed, at step the desired printing data is transmitted to the wireless printer using the short-distance wireless communication unit 114.

As shown in FIG. 6, at step 402 after the wireless printer 200 receives the printing data from the portable terminal 100, it advances to step 404, where the wireless printer 200 stores the printing data in the buffer memory 206. Further, at step 406 the wireless printer 200 determines whether a print request by the user is present. If the wireless printer 200 receives a print request signal from the button unit 208 as the user pushes the button corresponding to the print request, it advances to step 408 in order to print the printing data stored in the buffer memory 206 by means of the printing unit 212.

As described hereinabove, the portable terminal of the present invention transmits the printing data to be printed to the wireless printer using short-distance wireless communication, and the wireless printer receives the printing data using short-distance wireless communication and prints the printing data. Accordingly, the present invention has an advantage over the prior art in that wire cables are not necessary for each piece of equipment and the data transmission time can be reduced, because the data of the portable terminal is directly transmitted to the wireless printer and is printed without using an intermediate device such as a PC. In addition, the present invention satisfies users' demand, because a downloaded image, for example, a photo taken by a user, text prepared by a user, or the like can be promptly printed without leaving copies on the intermediate devices.

While the invention has been shown and described with reference to certain preferred embodiments thereof, it will be understood by those skilled in the art that various changes in form and details may be made therein without departing from the spirit and scope of the invention as defined by the appended claims.

1. A system for printing data from a portable terminal, the system comprising:
a portable terminal for storing printing data and transmitting desired printing data selected by a user using short-distance wireless communication, when a request for printing the desired printing data is present; and
a wireless printer for receiving the desired printing data using the short-distance communication and for printing the received printing data.

2. A system for printing data from a portable terminal as claimed in claim 1, wherein the printing data includes images and text downloaded from other devices or prepared on the portable terminal.

3. A system for printing data from a portable terminal as claimed in claim 1, wherein the portable terminal comprises:
a memory unit for storing the printing data;
a key input unit which is equipped with a key corresponding to the print request and outputs the print request signal, when the user pushes the key corresponding to the print request;
a display unit for displaying the stored printing data;
a short-distance wireless communication unit for transmitting desired printing data using short-distance wireless communication; and
a control part, which makes the display unit display the printing data stored at the memory unit, when the print request signal is inputted, and makes the short-distance wireless communication unit transmit the desired printing data using short-distance wireless communication, when the desired printing data is selected.

4. A system for printing data from a portable terminal as claimed in claim 3, wherein the short-distance wireless communication unit carries out any one of short-distance wireless communication selected from Bluetooth, Zigbee and UWB (Ultra Wide Band).

5. A system for printing data from a portable terminal as claimed in claim 1, wherein the wireless printer comprises:
a short-distance wireless communication unit for receiving the printing data from the portable terminal using short-distance wireless communication;
a buffer memory for temporarily storing the received printing data; and
a printing unit for printing the received printing data.

6. A system for printing data from a portable terminal as claimed in claim 5, wherein the short-distance wireless communication unit carries out any one of short-distance wireless communication selected from Bluetooth, Zigbee and UWB (Ultra Wide Band).

7. A method for printing data from a portable terminal, the method comprising the steps of:
displaying printing data stored previously on the portable terminal, when the user's request for printing desired data is present;
sending the desired printing data using a short-distance wireless communication unit, when the desired printing data is selected; and
a wireless printer receiving and printing the desired printing data using a short-distance wireless communication unit.

8. A method for printing data from a portable terminal, the method comprising the steps of:
recognizing peripheral wireless printer compatible with the portable terminal;
displaying the recognized wireless printers, when a request for printing desired data is present;
displaying the printing data, when a designated wireless printer is selected by the user from the recognized wireless printers;
transmitting the desired data to the designated wireless printer, when the desired data is selected by the user from the printing data; and
receiving the desired data by a wireless printer using a short-distance wireless communication unit and printing the received desired data.
